(19) United States
(12) Patent Application Publication
(10) Pub. No.: US 2004/0239750 A1
(43) Pub. Date: Dec. 2, 2004

(54) Method for the production of a dial and dial produced according to said method

(76) Inventors: Bernward Kneer, Karlstein (DE); Ingo Kopsieker, Seligenstadt (DE)

Correspondence Address: COHEN, PONTANI, LIEBERMAN & PAVANE, 551 FIFTH AVENUE, SUITE 1210, NEW YORK, NY, 10176, US

(21) Appl. No.: 10/488,201

(22) PCT Filed: Aug. 29, 2002
(86) PCT No.: PCT/DE02/03197

(30) Foreign Application Priority Data
Aug. 29, 2001 (DE) 101 41 751.9

(51) Int. Cl. B41J 2/435

(52) U.S. Cl. 347/224

(57) ABSTRACT

The invention relates to a method for the production of a dial, wherein a base body (1) is provided with at least one lacquered layer (6,7), said lacquered layer (6,7) being subsequently partially removed by means of a laser beam in order to produce scale graduation marks and/or figures (4) and/or markings.

The invention relates to a method for the production of a dial which has a base body with scale graduation marks and/or figures and/or markings. Furthermore, the invention relates to a dial produced according to this method.

Conventional dials comprise as the base body a sheet of plastic or a metal sheet which has been provided with the desired scale graduation marks and/or figures and/or markings by screen printing. The screen printing process gives rise to various restrictions with regard to the design of such dials. Printing onto non-planar dials is entirely ruled out. Furthermore, suitability for printing is greatly dependent on the surface roughness. If the roughness is too great, unsharp contours and spot formation occur. One disadvantage of the screen printing process is that the production of the printing screen represents a significant cost factor, with the result that changes to the dial become expensive.

The invention is based on the problem of developing a method for the production of a dial which allows the greatest possible freedom of design and can be performed with as little cost as possible.

Furthermore, a dial created according to this method is to be developed.

The first-mentioned problem is solved according to the invention by the base body initially being provided with at least one lacquer layer and by the lacquer layer subsequently being partially removed by means of a laser beam to produce the scale graduation marks and/or figures and/or markings.

By producing the scale graduation marks and/or figures and/or markings in this way according to the invention by the laser process, there is no longer the requirement for the base body that is to be printed on to be planar. Furthermore, it may have a rough or shiny surface, without this causing the print to become unsharp with regard to its contours. Changing the appearance of the dial is also easily possible, because all that is required for this purpose is to change the laser data in the control computer, so that this change can be performed quickly and with little cost. If the lacquer layer is opaque, particularly high contrast can be achieved, improving the readability. However, a translucent form of the lacquer layer is also conceivable, it being possible for the contrast ratio to be influenced for example by the selection of the color for the lacquer layer.

It is advantageous if, according to a development of the method, at least two lacquer layers of different colors are applied to the base body one on top of the other and if, according to the desired appearance of the scale graduation marks and/or figures and/or markings, only the outer lacquer layer or a number of lacquer layers are removed with the laser beam.

This allows for example markings to be produced with different colors, by using the laser beam to remove only one lacquer layer or a number of lacquer layers. The removal of not all the lacquer layers can be achieved for example by the material properties of the lacquer layers or by the time of exposure to or power of the laser.

The scale graduation marks and/or figures and/or markings can be illuminated by the transmitted-light method, improving the readability, if a translucent or transparent base body is used and the lacquer layer is at least partially removed in the region of the scale graduation marks and/or figures and/or markings.

Since the laser method does not require a smooth surface, it may be provided, to reduce reflections and for design reasons, that the outer lacquer layer is provided with a structuring.

According to the method according to the invention, no print layer has to adhere on the outer surface of the dial. Therefore, wettability of the surface is not important, so that it may be provided, according to another development of the invention, that the outer lacquer layer has a smooth surface.

The second-mentioned problem, that is the creation of a dial which has a base body with scale graduation marks and/or figures and/or markings, is solved according to the invention by the base body having at least one lacquer layer which has been partially removed by means of a laser beam to produce the scale graduation marks and/or figures and/or markings.

Such a dial may have a non-planar surface. Furthermore, it becomes possible to provide this surface with a structuring, without the transitions of the scale graduation marks and/or figures and/or markings becoming unsharp as a result. Therefore, the dial may have a design that cannot be realized with the previous screen printing technique.

It is advantageous if the base body has a number of lacquer layers of different colors one on top of the other and that only the outer lacquer layer or a number of lacquer layers have been removed in the region of the scale graduation marks and/or figures and/or markings. This allows the individual scale graduation marks and/or figures and/or markings to have different colors.

It is also advantageous if, according to another development of the invention, the base body is translucent or transparent. This provides the possibility of illuminating the lacquer layer in desired regions by the transmitted-light method by at least partial removal of the latter.

Particular stylistic effects can be achieved if the outer lacquer layer has a structuring or a shiny surface.

The invention allows various embodiments. For further illustration of its basic principle, one of these is described below and represented in the drawing, in which:

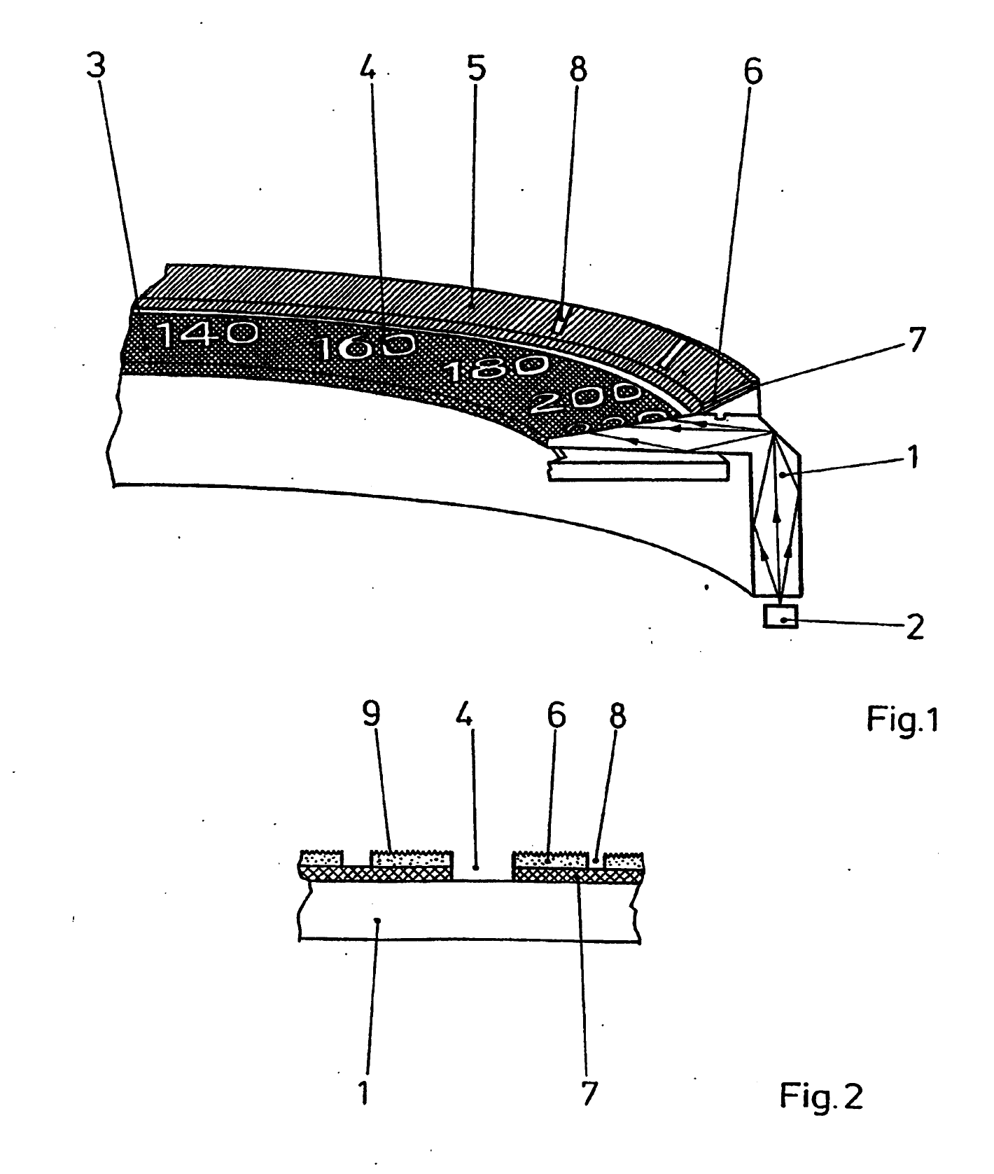

FIG. 1 shows a partial region of an annular dial according to the invention,

FIG. 2 shows a section through a dial according to the invention.

The dial represented in FIG. 1 has a base body 1 of transparent, light-conducting material. Light is coupled into this base body 1 by means of a light source 2, which in this case is an LED. An opaque lacquer layer 3, in which FIGS. 4 have been produced by removal of this lacquer layer 3, can be seen on the dial. These FIGS. 4 appear as luminous regions of the dial when the light source 2 is switched on.

The dial also has an annular region 5, which is coated by two lacquer layers 6, 7 lying one on top of the other. In this case, the outer lacquer layer 6 is for example opaque, while the lower lacquer layer 7 is translucent, but has a desired coloration. Markings 8, which have been produced by removal of just the outer lacquer layer 6, are provided in the outer lacquer layer 6. As a result, these markings 8 are luminous in the color of the lower lacquer layer 7.

FIG. 2 serves for additionally illustrating the invention. It shows a partial region of the base body 1 with the two lacquer layers 6, 7 on an enlarged scale and in section. It can be seen that, to produce the FIG. 4, both lacquer layers 6, 7 have been removed, so that light can leave freely from the base body 1. The markings 8- penetrate only the outer lacquer layer 6, so that they appear in the color of the lower lacquer layer 7. The outer lacquer layer 6 may be shiny or have a structuring 9, as represented in FIG. 2.

To produce the scale graduation marks and/or figures and/or markings, a spatially adjustable laser beam is used, removing one lacquer layer 6 or else both lacquer layers 6, 7 by exposure to its heat under appropriate control (for example with the aid of a computer program). If they are to be removed completely in the desired regions, the lacquer layers 6, 7 must be laser-compatible. If, for example, the lower layer does not have to be removed anywhere, it may also be formed such that it is laser-resistant.

1-10. (canceled)

11. A method for producing a dial having a base body and indications, comprising the steps of:
applying at least one lacquer layer on a base body; and
removing selected areas of the lacquer layer using a laser beam to produce indications, wherein the indications comprise at least one of scale graduation marks, figures, and markings.

12. The method of claim 11, wherein said step of applying comprises applying a first lacquer layer on said base body and at least an outer lacquer layer on said first lacquer layer, wherein said first and outer lacquer layers are different colors, and said step of removing comprises removing the outer lacquer layer and leaving the first lacquer layer in selected areas using the laser beam to produce at least a portion of the indications.

13. The method of claim 12, wherein the base body is one of translucent and transparent and said step of removing comprises removing the first and outer lacquer layers in selected areas using the laser beam to produce other portions of the indications.

14. The method of claim 11, wherein said step of applying further comprises applying a structuring on an outer lacquer layer of the at least one lacquer layer.

15. The method of claim 11, wherein the at least one lacquer layer is applied such that an outer lacquer layer of the at least one lacquer layer has a smooth surface.

16. A dial, comprising a base body and at least one lacquer layer applied on said base body, wherein indications are formed on said dial in selected areas where said at least one lacquer layer is removed by a laser beam, said indications comprising at least one of scale graduation marks, figures, and markings.

17. The dial of claim 16, wherein said at least one lacquer layer comprises a first lacquer layer arranged on said base body and at least an outer layer arranged on said first lacquer layer, wherein said outer layer is removed by a laser beam and the first lacquer layer is retained on said base body in selected areas to form at least a portion of said indications.

18. The dial of claim 16, wherein said base body is one of translucent and transparent.

19. The dial of claim 16, wherein an outer layer of said at least one lacquer layer comprises an outer surface with a structuring.

20. The dial of claim 16, wherein an outer layer of said at least one lacquer layer comprises a smooth outer surface.

21. The dial of claim 17, wherein others of said indications are formed by removal of both said first lacquer layer and said outer layer in selected areas.
